(19) United States
(12) Patent Application Publication
(10) Pub. No.: US 2008/0080075 A1
(43) Pub. Date: Apr. 3, 2008

(54) Mirror device

(76) Inventor: Chadd Tsuyoshi Kawai, Los Angeles, CA (US)

Correspondence Address: CHADD KAWAI, 7860 LULU GLEN DR, LOS ANGELES, CA, 90046, US

(21) Appl. No.: 11/903,133

(22) Filed: Sep. 20, 2007

Related U.S. Application Data
(60) Provisional application No. 60/849,359, filed on Oct. 3, 2006.

(51) Int. Cl. G02B 5/08

(52) U.S. Cl. 359/850

(57) ABSTRACT

A mirror device for providing a user with an image of what a fully framed and/or matted picture will look like based on an “L” shaped frame and/or matte sample placed at a corner of the picture.

I hereby claim priority to my earlier filed U.S. Provisional Patent Application No. US60/849,359 filed on Oct. 3, 2006.

### FIELD OF THE INVENTION

The invention relates generally to a mirror device, and more particularly to an apparatus for reflecting an image of a partially framed object.

### BACKGROUND

Framing a picture usually involves placing an “L” shaped frame sample and an “L” shaped matte sample on one corner of the picture in order to give the owner an idea of what the picture would look like when fully framed. Unfortunately, doing so only gives the owner a small and incomplete idea of what the picture would look like when fully framed. Ideally, owners would be able to place a sample of the frame and matte completely around the picture in order to provide a complete image of the framed picture. Obviously that is not practical since the cost and space required to maintain such a volume of samples would be prohibitive. What is therefore needed is a device for allowing a person to better visualize what a fully framed picture will look like using the industry standard “L” shaped frame and matte samples.

### SUMMARY

In particular, and by way of example only, one embodiment of the invention is an apparatus for allowing a person to better visualize a fully framed picture having a generally rectangular shape with left and right parallel edges joined at right angle corners to top and bottom parallel edges, the apparatus comprising a first mirror panel having left and right parallel edges joined at right angle corners to top and bottom parallel edges and a reflective front face; and a second mirror panel having left and right parallel edges joined at right angle corners to top and bottom parallel edges and a reflective front face, wherein the right edge of the first mirror panel is coupled to the left edge of the second mirror panel such that the two panels form a ninety degree angle.

These and other features and advantages of the embodiments of the invention will become apparent from the following detailed description, taken in conjunction with the accompanying drawings, which illustrate, by way of example, the principles of the invention.

### BRIEF DESCRIPTION OF THE DRAWINGS

FIG. 1 is perspective drawing of a mirror device.

FIG. 2 is a perspective drawing of a mirror device in use against an “L” shaped matte and frame sample.

### DETAILED DESCRIPTION OF THE DISCLOSURE

Devices and methods that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

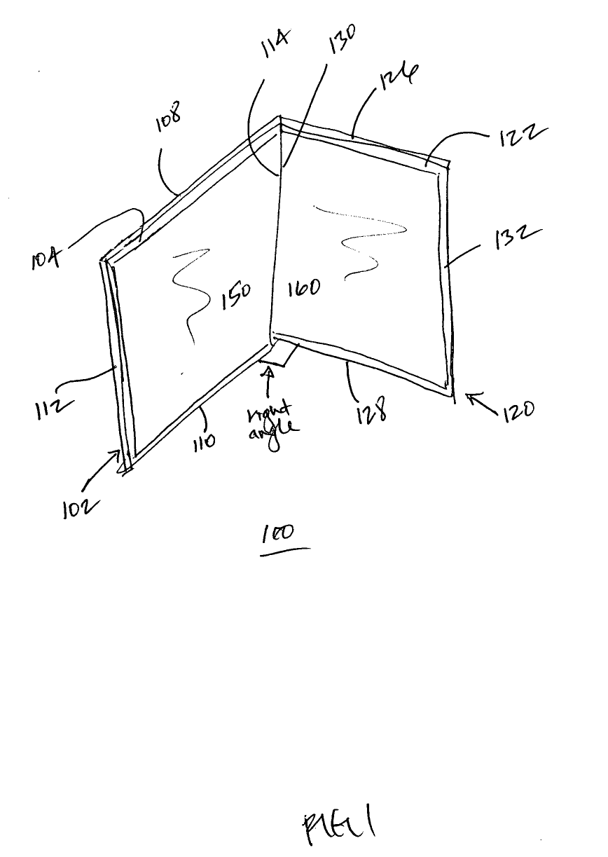

Referring now more particularly to the drawings, FIG. 1 illustrates a first embodiment of a mirror device 100 for allowing a person to better visualize a fully framed picture. The mirror device 100 is comprised of a first panel 102 having a front side 104, a top edge 108, a bottom edge 110, a left edge 112 and a right edge 114. The mirror device is also comprised of a second panel 120 having a front side 122, a top edge 126, a bottom edge 128, a left edge 130 and a right edge 132. The right edge 114 of the first panel 102 is coupled to the left edge 130 of the second panel 120 so that the first and second panels 102 and 130 form a right angle. The first panel 102 and the second panel 130 may be coupled together using glue or nails or other coupling device to permanently maintain a right angle. They may also be hinged together (using any commonly known hinging means such as a metal door type hinge, string, leather, fabric, flexible plastic, etc) so that the angle between the first panel 102 and the second panel 120 is adjustable, thereby allowing the first panel 102 and second panel 120 to fold flat like a book when not in use. The first and second panels may be made from, but are not limited to, wood, metal, plastic, cardboard or any other flat surface.

Affixed to the front side of the first panel is a first reflective surface 150 and to the front side of the second panel is a second reflective surface 160. The reflective surfaces 150 and 160 may be, but are not limited to, a mirror, polished metal, polished plastic or glass. Alternatively, the first and second panels and the reflective surfaces may be an integrated item so that the front side of the first and second panels are reflective.

Coupled to the bottom edge of the first panel may be an optional first foot 170 and to the bottom edge of the second panel may be an optional second foot 180. The optional feet 170 and 180 may be incorporated for stability and to create a smooth bottom surface which will prevent scratches or to provide a larger area to affix a scratch resisting material such as felt. Alternatively, a scratch resistant material may be affixed directly to the bottom edge of the first and second panels.

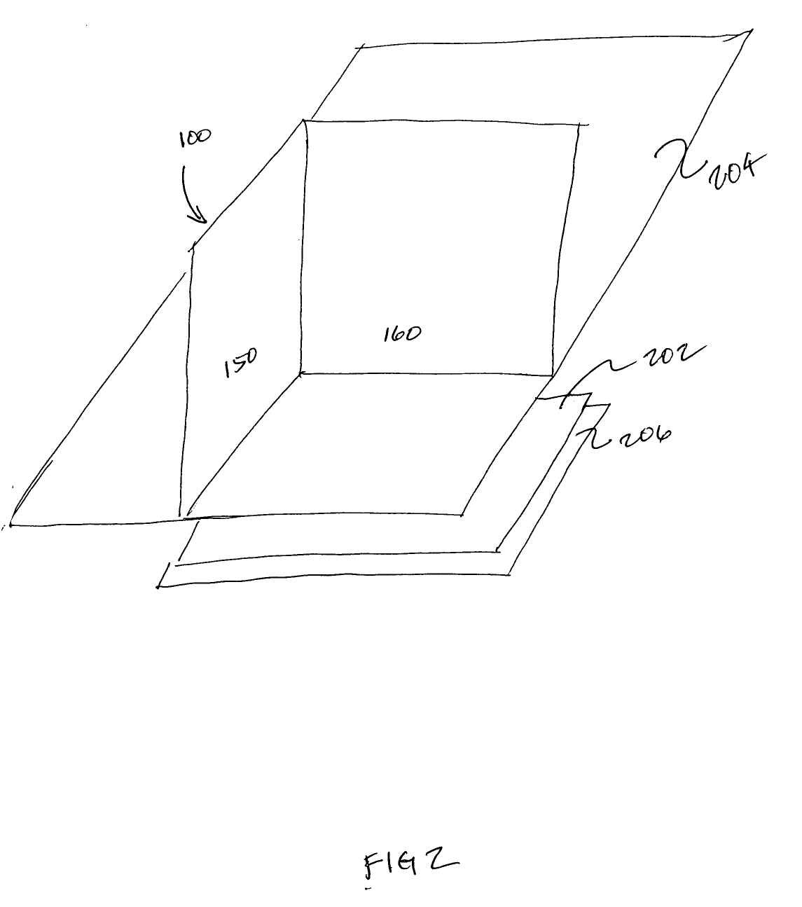

FIG. 2 illustrates the mirror device in use. As is typical in the framing business, an “L” shaped matte sample 202 is seated at one corner of a picture 204 to be framed. An “L” shaped frame 206 is also seated at the corner of the matte 202. The mirror device 100 is placed such that the front sides of the first and second panels are facing the matte sample 202 and frame sample 206. The reflection of the partially framed picture in the reflective surfaces will give the illusion that the picture has four edges that are all framed and matted.

Although exemplary embodiments of the invention have been shown and described, many other changes, combinations, omissions, modifications and substitutions, in addition to those set forth in the above paragraphs, may be made by one having skill in the art without necessarily departing from the spirit and scope of this invention. Accordingly, the invention is not intended to be limited by the preferred embodiments, but is to be defined by reference to the appended claims.

We claim:

1. An apparatus for allowing a person to better visualize a fully framed picture having a generally rectangular shape with left and right parallel edges joined at right angle corners to top and bottom parallel edges, the apparatus comprising:
A first mirror panel having left and right parallel edges joined at right angle corners to top and bottom parallel edges and a reflective front face; and
A second mirror panel having left and right parallel edges joined at right angle corners to top and bottom parallel edges and a reflective front face, wherein the right edge of the first mirror panel is coupled to the left edge of the second mirror panel such that the two panels form a ninety degree angle.

2. The apparatus of claim 1 wherein the first mirror panel and the second mirror panel are coupled together by a hinge means that allows the first mirror panel and the second mirror panel to rotate about the hinge means in order for the first mirror panel and the second mirror panel to close flat against each other or open to form a ninety degree angle.
